(19) United States
(12) Patent Application Publication
(10) Pub. No.: US 2010/0021219 A1
(43) Pub. Date: Jan. 28, 2010

(54) Sheet transporting device

(75) Inventor: Eiji Hori, Tokyo (JP)

Correspondence Address: KANESAKA BERNER AND PARTNERS LLP, 1700 DIAGONAL RD, SUITE 310, ALEXANDRIA, VA, 22314-2848, US

(73) Assignee: Riso Kagaku Corporation, Tokyo (JP)

(21) Appl. No.: 12/310,795

(22) PCT Filed: Oct. 3, 2007
(86) PCT No.: PCT/JP2007/069786

§ 371 Date: Mar. 6, 2009

(30) Foreign Application Priority Data
Dec. 22, 2006 (JP) 2006-346303

(51) Int. Cl. G03G 15/00

(52) U.S. Cl. 399/388

(57) ABSTRACT

Fixed electrodes 16a having a positive potential are disposed in positions not corresponding to the positions of print heads and covered with a dielectric layer 17. A conveyor belt 10 includes a conductor layer 11 having a negative potential and a dielectric layer 12 in the surface and has holes 13, 14 through which electrical flux lines from the fixed electrodes pass. Since electrical flux lines from the dielectric layer of the fixed electrodes pass through the holes and polarize a sheet S placed on the dielectric layer 12 of the conveyor belt 10 as well as the dielectric layer 12, the sheet is electrostatically adsorbed to the conveyor belt in the vicinity of the holes. With the movement of the conveyor belt along the fixed electrodes, the sheet is transported, while being electrostatically adsorbed to the conveyor belt. The inventive device of a simple structure provides stable adsorptive power and a stable speed of transportation and is free from ink droplet deflection by electric fields.

### TECHNICAL FIELD

The present invention relates to a sheet transporting device that transports sheets by means of electrostatic adsorption and particularly to a sheet transporting device of an electrostatic adsorption type that can bring a lot of benefits in a sheet transporting device that is used in an image forming apparatus, forming an image on a sheet by ink jetting onto the sheet by print heads, and has a function of transporting a sheet along the print heads, while keeping the sheet in contact with a belt by electrostatic adsorption. In the present application, sheets refer to a sheet-like print medium such as, for example, printing paper, film, a rolled web of a sheet-like material, and a woven material.

### BACKGROUND ART

In an image forming apparatus that forms an image on paper which is a sheet by aqueous ink jetting onto it from a print head, paper to which ink is transferred may be swollen and cockled. When such paper is re-fed and duplex printing of the paper is performed, the forward end of the paper may warp up and collide with rollers, print heads, and like along a transport path, which increases the likelihood that a paper jam occurs during transportation.

To solve such a problem, a sheet transporting device that applies the principle of electrostatic adsorption is considered to be effective as the one that is used in the above image forming apparatus. Sheet transporting means such as those described in Patent Documents 1 through 3 mentioned below are known.

As is illustrated in FIG. 13 and FIG. 14, sheet transporting means disclosed in Patent Document 1 is configured having comb-shaped electrodes 100, 101 which mesh with each other such that comb-teeth sections of each are disposed alternately, one electrode being connected to a positive potential and the other electrode being connected to a negative potential, and a conveyor belt 102 made of a dielectric material moves over the electrodes. The conveyor belt 102 is polarized by the positively or negatively charged comb-shaped electrodes 100, 101 being under the belt and the surface of the belt is charged accordingly. Thereby, it is possible to adsorb and carry paper P on the conveyor belt 102.

As is illustrated in FIG. 15 and FIG. 16, sheet transporting means disclosed in Patent Document 2 has electrodes 202 embedded in a conveyor belt 201. These electrodes 202 constitute a group of plural rectangular electrodes, separate from each other, with their longitudinal direction intersecting with a transport direction, wherein the electrodes are led to both edges of the conveyor belt 201 and charged positively or negatively alternately with respect to the transport direction by positive or negative brush-like charging members, each being arranged along both edges of the conveyor belt 201. Thereby, it is possible to adsorb and carry paper P on the conveyor belt 201.

As is illustrated FIG. 17, a sheet transporting means disclosed in Patent Document 3 is arranged such that a charging roller 303 connected to an AC power supply 302 rotatably contacts the undersurface of a conveyor belt 301 made of a insulating material and changes the conveyor belt 301 positively or negatively alternately with respect to the transport direction. Thereby, it is possible to adsorb and carry paper P on the conveyor belt 301.

Patent Document 1: Japanese Published Patent Application No. 2004-90533

Patent Document 2: Japanese Published Patent Application No. 2000-247476

Patent Document 3: Japanese Published Patent Application No. 2003-103857

However, according to the sheet transporting means wherein interdigital electrodes are fixed, described in Patent Document 1, because the conveyor belt 102 adheres to the comb-shaped electrodes 100, 101, the load of transportation is increased, which poses a problem of increasing power consumption. Due to the structure in which the comb-shaped electrodes 100, 101 charged positively and negatively alternately are fixed and the conveyor belt 102 moves relative to the electrodes, positively or negatively charged portions of the conveyor belt 102 polarized according to the potentials of the comb-shaped electrodes 100, 101, as schematically shown in FIG. 14(a), come to instantaneously counteract the negative or positive potential of the adjacent comb-shaped electrode 100, 101 when the conveyor belt 102 moves and a repulsion force is momentarily produced between the conveyor belt 102 and the comb-shaped electrodes 100, 101, as schematically shown in FIG. 14(b), and this causes resistance to transportation. Thus, according to this sheet transporting means, unstable adsorptive power results in unstable speed of transportation of the conveyor belt 102 and the way of movement of the conveyor belt 102 becomes intermittent, if expressed in an extreme manner, and a problem of degrading the print quality of printed images is presented.

According to the sheet transporting means wherein electrodes are embedded in the belt, described in Patent Document 1, the conveyor belt 201 is placed in a tense state on a roller. Since, in a bending position of the conveyor belt 201 placed in a tense on the roller, the embedded electrode 202 itself does not bend, a problem that a large load is applied to the conveyor belt 201 and the belt is prone to deterioration is presented. For the same reason noted for the art described in Patent Document 1, a problem of intermittent movement of the conveyor belt 201 is also posed. In addition, because of the conveyor belt 201 structure in which the electrodes are embedded, the thickness of the conveyor belt 201 is relatively larger than the structures of other sheet transporting means. Consequently, thickness variation occurs especially in the roller portion and the distance from the center of the roller to the surface of the conveyor belt 201 varies, which poses another problem that there is a variation in the speed of transportation on the surface of the conveyor belt 201. Yet another problem is that a manufacturing process is complicated, because the electrodes 202 are embedded in the conveyor belt 201. Yet another problem is that the means (such as the above-mentioned brush-like charging members) for applying a voltage to the embedded electrodes from outside the conveyor belt 201 is complicated.

According to the sheet transporting means with the charging roller, described in Patent Document 3, since the conveyor belt 301 is charged by the charging roller 303, on the conveyor belt 301 charged by the charging roller 303, adjacent positive and negative charges start to cancel with each other immediately after leaving the charging roller 303, and also attenuate due to leak, which poses a problem that sufficient adsorptive power cannot be gained in the case of long-distance transportation and under a high humidity condition. To address this problem, it is conceivable to provide additional charging rollers 303 contacting the conveyor belt 301. However, simply increasing the number of charging rollers 303 inevitably results in cost rise. Even if plural charging rollers 303 are disposed, placing these rollers on the print side is impracticable because doing so increases the likelihood of smearing the print side of paper, and a problem that considerable difficulty is encountered in practically disposing these rollers is presented. Moreover, in the method in which the conveyor belt 301 is charged by the charging roller 303, a problem that it is hard to make adsorptive power variable locally is also presented.

The present invention, which is made in view of the above-noted problems, is intended to provide a sheet transporting device that transports sheets by means of electrostatic adsorption and particularly a sheet transporting device that is used in an image forming apparatus, forming an image on a sheet by ink jetting onto the sheet by print heads, and transports a sheet along the print heads, while electrostatically adsorbing the sheet to a belt, wherein the sheet transporting device has a simple structure with the capability of achieving stable adsorptive power and stable speed of transportation, is insusceptible to humidity, and reduces the possibility of ink droplet deflection by the influence of electric fields.

### DISCLOSURE OF INVENTION

A sheet transporting device described in claim 1 is a sheet transporting device for transportation of a sheet, including a fixed electrode having a first potential applied thereto and provided with a dielectric layer on its surface facing a transportation path of the sheet and a conveyor belt driven circulatively relative to the dielectric layer of the fixed electrode in a sheet transport direction and including a conductor having a second potential applied thereto and having plural through holes formed therein, allowing electrical flux lines from the fixed electrode to pass through, wherein the sheet is electrostatically adsorbed to a belt surface opposite to the fixed electrode.

A sheet transporting device described in claim 2 is a sheet transporting device provided in an image forming apparatus forming an image on a sheet by ink jetting onto the sheet from plural print heads disposed, spaced at an interval, for transportation of the sheet along the print heads, including a fixed electrode disposed underneath the print heads, having a first potential applied thereto, and provided with a dielectric layer on its surface facing the print heads and a conveyor belt driven circulatively relative to the dielectric layer of the fixed electrode in a sheet transport direction and including a conductor having a second potential applied thereto and having plural through holes formed therein, allowing electrical flux lines from the fixed electrode to pass through, wherein the sheet is electrostatically adsorbed to a belt surface on the print head side.

In the present invention, the first potential and the second potential means two different potentials between which a potential difference is appreciated. For example, if the first potential is positive, the second potential is 0 or negative. If the first potential is 0 or negative, the second potential is positive. Not only such combination of a positive potential and a negative or 0 potential, but another example where a potential difference between both is appreciated, in which the first potential is +3 V and the second potential is +1 V or that the first potential is −3 V and the second potential is −5 V.

A sheet transporting device described in claim 3 is the sheet transporting device according to claim 1 or 2, characterized in that the fixed electrode is divided into plural elements arranged in the sheet transport direction.

A sheet transporting device described in claim 4 is the sheet transporting device according to claim 3, characterized in that the plural divisional elements of the fixed electrode are disposed in positions not corresponding to the positions of the print heads.

A sheet transporting device described in claim 5 is the sheet transporting device according to one of claims 1 through 4, characterized in that the conveyor belt is provided with a dielectric layer in its surface on which a sheet is placed and plural openings, each communicating with each of the through holes, are formed in the dielectric layer.

A sheet transporting device described in claim 6 is the sheet transporting device according to one of claims 1 through 4, characterized in that the conveyor belt is provided with a dielectric layer in its surface on which a sheet is placed and plural openings are formed in the dielectric layer to communicate with some of the plural through holes formed in the conveyor belt.

A sheet transporting device described in claim 7 is the sheet transporting device according to one of claims 1 through 4, including an eject roller installed aside downstream of the conveyor belt with respect to the sheet transport direction and ejecting a sheet having an image formed thereon downstream at a greater speed than a speed of the conveyor belt, while adsorbing the sheet and an electrostatic adsorptive electrode installed between one of the print heads located most downstream with respect to the sheet transport direction and the eject roller and producing electrostatic adsorptive power stronger than the adsorptive power of the eject roller when a sheet is positioned with its extension on both the print head located most downstream with respect to the sheet transport direction and the eject roller.

A sheet transporting device described in claim 8 is a sheet transporting device provided in an image forming apparatus forming an image on a sheet by ink jetting onto the sheet from print heads, the sheet transporting device including a conveyor belt for transportation of the sheet by moving along the print heads, while electrostatically adsorbing the sheet, and an eject roller installed aside downstream of the conveyor belt with respect to the sheet transport direction and ejecting the sheet having an image formed thereon downstream at a greater speed than a speed of the conveyor belt, while adsorbing the sheet, characterized in that an electrostatic adsorptive electrode is installed between one of the print heads located most downstream with respect to the sheet transport direction and the eject roller to produce electrostatic adsorptive power stronger than the adsorptive power of the eject roller when a sheet is positioned with its extension on both the print head located most downstream with respect to the sheet transport direction and the eject roller.

According to the sheet transporting device described in claim 1, if the first potential is positive and the second potential is 0 or negative, the fixed electrode having the first potential applied thereto polarizes the dielectric layer and produces positive charges on its surface. Resulting electrical flux lines pass through the through holes right above the fixed electrode among the through holes in the conveyor belt having the second potential applied thereto, arrive at and pass through a sheet placed on the surface of the conveyor belt, polarize the sheet, and produce positive and negative charges on the upper and under sides of the sheet. Hence, the sheet is electrostatically adsorbed to the conveyor belt in the through holes or their surroundings of the conveyor belt lying in a region adjacent to the fixed electrode. With the movement of the conveyor belt along the fixed electrode, the sheet is transported, while being electrostatically adsorbed to the conveyor belt.

In this way, it is possible to realize a sheet transporting device of even a simple structure, wherein application to each electrode is easy and stable adsorptive power and invariable stable speed of transportation can be achieved with reduced load on the conveyor belt. Further, the device is insusceptible to humidity.

According to the sheet transporting device described in claim 2, if the first potential is positive and the second potential is 0 or negative, the fixed electrode having the first potential applied thereto polarizes the dielectric layer and produces positive charges on its surface. Resulting electrical flux lines pass through the through holes right above the fixed electrode among the through holes in the conveyor belt having the second potential applied thereto, arrive at and pass through a sheet placed on the surface of the conveyor belt, polarize the sheet, and produce positive and negative charges on the upper and under sides of the sheet. Hence, the sheet is electrostatically adsorbed to the conveyor belt in the through hole portions or surroundings thereof lying in a region adjacent to the fixed electrode of the conveyor belt. With the movement of the conveyor belt along the fixed electrode, the sheet is transported, while being electrostatically adsorbed to the conveyor belt.

In this way, because a sheet is transported with the movement of the conveyor belt on which the sheet was adsorbed in a state of being adsorbed to the fixed electrode, the distance between the print heads and the sheet can be kept constant, thereby improving print quality.

According to the sheet transporting device described in claim 3, in the effect provided by the sheet transporting device according to claim 1 or 2, dividing the electrode with respect to the sheet transport direction produces an effect of reduced load of transportation.

According to the sheet transporting device described in claim 4, in the effect provided by the sheet transporting device according to claim 3, because the divisional fixed electrodes are disposed in positions not corresponding to the positions of the print heads, it is avoided that ink droplets jetted from the print heads are deflected in space under the influence of electric fields produced by the fixed electrodes.

According to the invention described in claims 2 through 4 as above, further, effects are obtained as described in the following (1) to (4).

(1) Simple Structure

Because of the simple structure in which the conveyor belt as a movable electrode having the second potential is moved relative to the fixed electrode having the first potential, wherein each electrode is independent, the inventive device is advantageous in terms of assembly workability and manufacturing cost in comparison with the prior-art sheet transporting device of electrostatic adsorption type using comb-shaped electrodes and the like. Positive and negative electrodes are disposed in a vertical relationship and it is easy to set a gap more easily and precisely between two electrodes that determines adsorptive power.

(2) Easy Voltage Application to Each Electrode

It is possible to apply a voltage to the fixed electrode by ordinary wiring connection and it is possible to apply a voltage to the conductive conveyor belt with is a movable electrode, for example, by using a roller or the like connected to a given potential.

(3) Reduced Variation of Transportation Speed

Two positive and negative electrodes are separate: the fixed electrode and the conveyor belt as the movable electrode. Therefore, the thickness of the conveyor belt itself is smaller and the belt surface has less irregularity in comparison with the prior-art transporting device of electrostatic adsorption type wherein electrodes are embedded in the conveyor belt. Hence, it is possible to reduce thickness variation, variation in the speed of transportation is reduced, and good print quality can be achieved.

The inventive device is free from intermittent transportation operation as in the prior-art sheet transporting device of electrostatic adsorption type using the comb-shaped electrodes and the like, in which positive and negative electrodes are arranged alternately. Because of smooth movement of the conveyor belt, good print quality can be achieved in this respect as well.

(4) Reduced Load of Conveyor Belt

Since through holes are formed in the conveyor belt moving as the movable electrode relative to the fixed electrode, the contact area between both electrodes becomes smaller and the load of transportation is reduced.

According to the sheet transporting device described in claim 5, in the effects provided by the sheet transporting device according to claims 1 through 4, electrical flux lines from positive charges on the surface of the dielectric layer polarized by the fixed electrode being at the first potential pass through the through holes right above the fixed electrode among the through holes in the conveyor belt having the second potential applied thereto and the openings in the dielectric communicating with these through holes, arrive at and pass through a sheet placed on the surface of the conveyor belt, and polarize the sheet. Further, the electrical flux lines arrive at and pass through the dielectric layer of the conveyor belt and polarize it. Consequently, positive and negative charges arise at the upper and under sides of each of the sheet and the dielectric layer such that the upper and under sides are charged oppositely to each other. The sheet is electrostatically adsorbed to the dielectric layer of the conveyor belt certainly in the through holes and their surroundings of the conveyor belt lying in the region adjacent to the fixed electrode.

According to the sheet transporting device described in claim 6, in the effects provided by the sheet transporting device according to claims 1 through 4, in portions where the through holes in the conveyor belt communicate with the openings in the dielectric layer, electrical flux lines from positive charges on the surface of the dielectric layer polarized by the fixed electrode being at the first potential pass through the through holes right above the fixed electrode among the through holes in the conveyor belt having the second potential applied thereto and the openings in the dielectric layer communicating with these through holes, arrive at and pass through a sheet placed on the surface of the conveyor belt, and polarize the sheet. Further, the electrical flux lines arrive at and pass through the dielectric layer of the conveyor belt and polarize it. Consequently, positive and negative charges arise at the upper and under sides of each of the sheet and the dielectric layer such that the upper and under sides are charged oppositely to each other. The sheet is electrostatically adsorbed to the dielectric layer of the conveyor belt certainly in the through holes and their surroundings of the conveyor belt lying in the region adjacent to the fixed electrode.

On the other hand, in portions where the through holes in the conveyor belt closed by the dielectric layer, the electrical flux lines from positive charges on the surface of the dielectric layer polarized by the fixed electrode being at the first potential pass through the through holes right above the fixed electrode among the through holes in the conveyor belt having the second potential applied thereto and the dielectric layer closing these through holes, arrive at and pass through a sheet placed on the surface of the conveyor belt, and polarize the sheet. Further, the electrical flux lines arrive at and pass through the dielectric layer of the conveyor belt and polarize it. Consequently, positive and negative charges arise at the upper and under sides of each of the sheet and the dielectric layer such that the upper and under sides are charged oppositely to each other. The sheet is electrostatically adsorbed to the dielectric layer of the conveyor belt in the through holes and their surroundings of the conveyor belt lying in the region adjacent to the fixed electrode.

However, charges are accumulated over time in the portions closing the through holes in the dielectric layer of the conveyor belt, becoming equivalent to the charges in the remaining portions of the dielectric layer of the conveyor belt. This shuts off the electrical flux lines penetrating the sheet and the upper and under sides of the sheet become uncharged, resulting in a decrease in the power of adsorbing the sheet to the dielectric layer.

Accordingly, among the through holes formed in the conveyor belt, if vertical through holes communicating with the openings formed in the dielectric layer and holes closed by the dielectric layer are formed to be distributed appropriately, sections where adsorptive power is maintained and sections where adsorptive power attenuates over time can be distributed arbitrarily in an adsorption region of the conveyor belt. Hence, in the transportation of a sheet on the conveyor belt using electrostatic adsorption, it is possible to retain the sheet in the adsorption region of the conveyor belt certainly with strong adsorptive power at the start of adsorption of the sheet and allow excess adsorptive power to attenuate over time, while keeping the adsorptive power required to transport the sheet during the transportation of the sheet. Thus, it is possible to improve image reproducibility by eliminating to some degree a disadvantage in which the directions of ink droplets jetted toward a sheet from the print heads are deflected by the influence of the charges. When the sheet is going to be ejected, coming to a position out of the last print head in the transport direction by the movement of the conveyor belt, the power of adsorbing the rear end of the sheet readily attenuates. This improves sheet separation when a sheet is ejected (drop off the conveyor belt) and improves the alignment of sheets after being ejected.

Especially, in the case where the fixed electrode includes plural divisional elements, because charges on a sheet are uncharged readily in the position of a print head between fixed electrodes, the disadvantage in which the directions of ink droplets jetted toward a sheet from the print heads are deflected by the influence of the charges is effectively eliminated. This improves image reproducibility and improves sheet separation when a sheet is ejected (drop off the conveyor belt). Poor sheet alignment in the paper collector due to charged sheets is reduced.

According to the sheet transporting device described in claim 7, in the effect provided by the sheet transporting device according to one of claims 2 through 6, it is avoided that a sheet is pulled ahead by the eject roller and its position misalignment to the print head occurs and an effect of preventing print quality degradation such as misregistration of colors is achieved.

According to the sheet transporting device described in claim 8, when, by ink jets by the print heads, an image is formed on a sheet being electrostatically adsorbed and transported, and the sheet is eventually ejected at a higher speed than a speed of the conveyor belt, in a state where a sheet is positioned with its extension on the print head located most downstream in the sheet transport direction and the eject roller, while printing continues, the electrostatic adsorptive electrode installed between the print head and the eject roller retains the sheet with electrostatic adsorptive power stronger than the adsorptive power of the eject roller. Thus, it is avoided that the sheet is pulled ahead by the eject roller and its position misalignment to the print head occurs and print quality degradation such as misregistration of colors is prevented.

In this way, according to the invention described in claims 7 and 8, since misregistration of colors occurring due to the pull of a sheet by the eject roller during printing is rectified, it is possible to shorten the distance between the last print head in the transport direction and the eject roller and device size reduction can be realized. Because the ejection speed of the eject roller has no influence on transportation of a sheet during image formation, it is possible to make the speed of the eject roller sufficiently greater than the transportation speed of the conveyor belt, which improves paper ejection, reduces paper jam during ejection, and improves alignment of ejected sheets.

### BRIEF DESCRIPTION OF THE DRAWINGS

FIG. 1 is an overall structural diagram of a first embodiment of the present invention.

FIG. 2 is a cross-sectional view showing how a conveyor belt and its surrounding members are charged in the first embodiment.

FIG. 3 is a cross-sectional view showing how the conveyor belt and its surrounding members are charged in a second embodiment.

FIG. 4 is a cross-sectional view showing how the conveyor belt and its surrounding members are charged in the second embodiment.

FIG. 5 is an overall structural diagram of a third embodiment of the present invention.

FIG. 6 is a perspective view showing adsorption regions of the conveyor belt in the vicinity of the conveyor belt of the third embodiment.

FIG. 7 is an overall structural diagram of a modification example of the third embodiment of the present invention.

FIG. 8 is an overall structural diagram of a fourth embodiment of the present invention.

FIG. 9 is an overall structural diagram of a modification example of a fifth embodiment of the present invention.

FIG. 10 is a schematic perspective view of an electrostatic adsorptive electrode of a sixth embodiment.

FIG. 11 is an overall structural diagram of a seventh embodiment of the present invention.

FIG. 12 is an overall structural diagram of a modification example of an eighth embodiment of the present invention.

FIG. 13 is a plan view of interdigital electrodes which are used in a prior-art sheet transporting device of an electrostatic transporting type.

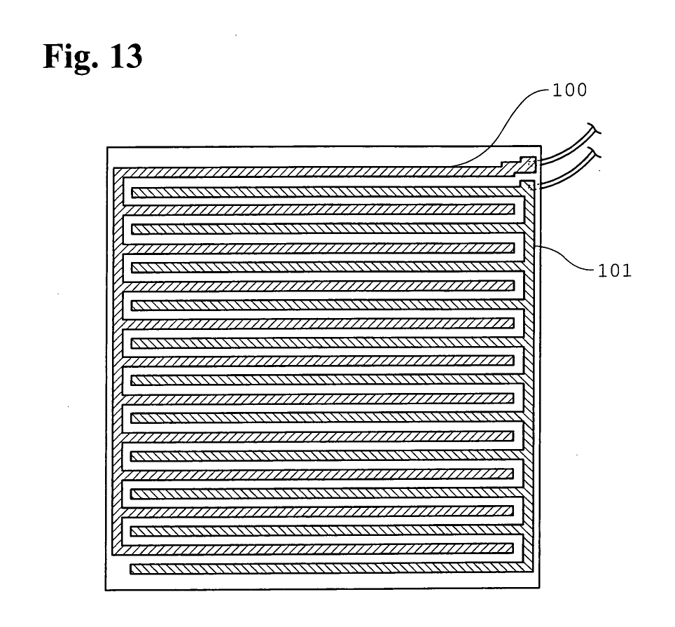

FIG. 14 is a cross-sectional view showing how a conveyor belt and its surrounding members are charged in the prior-art sheet transporting device of the electrostatic transporting type using the interdigital electrodes.

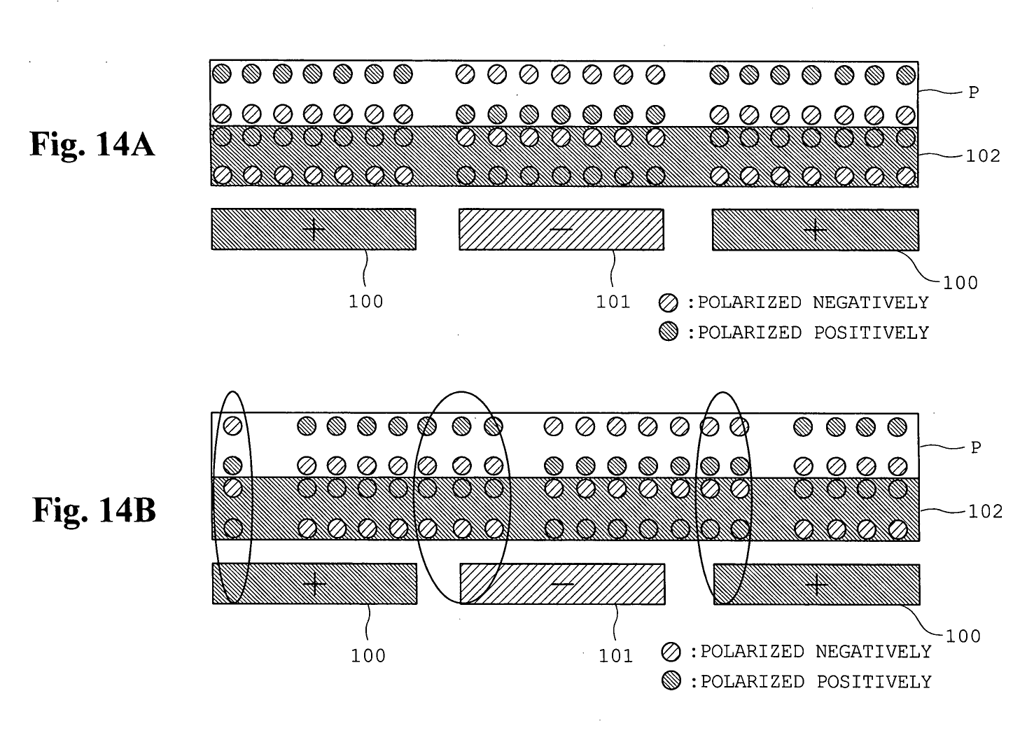

FIG. 15 is a front view of a prior-art sheet transporting device of an electrostatic transporting type having electrodes embedded therein.

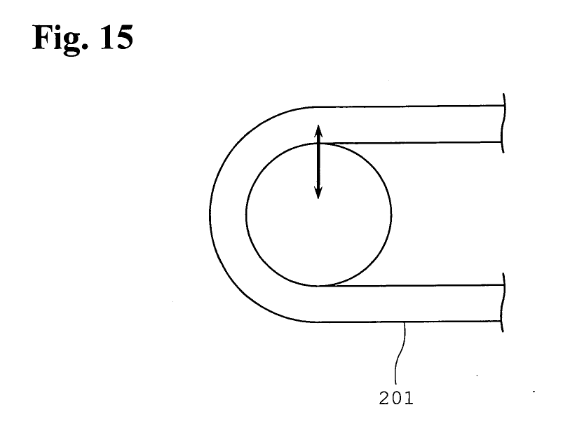

FIG. 16 is a cross-sectional view of a conveyor belt in the priori-art sheet transporting device of the electrostatic transporting type having electrodes embedded therein.

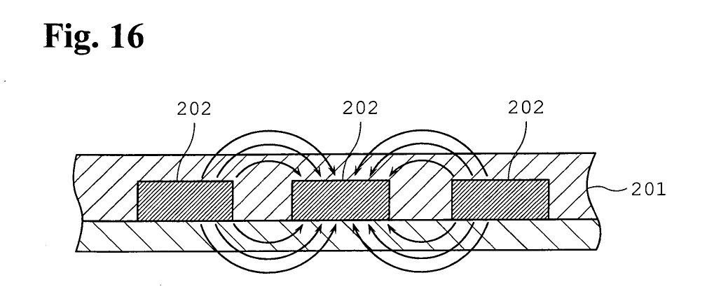

FIG. 17 is a cross-sectional view of a conveyor belt and its surroundings in a prior-art sheet transporting device of an electrostatic transporting type having a charging roller.

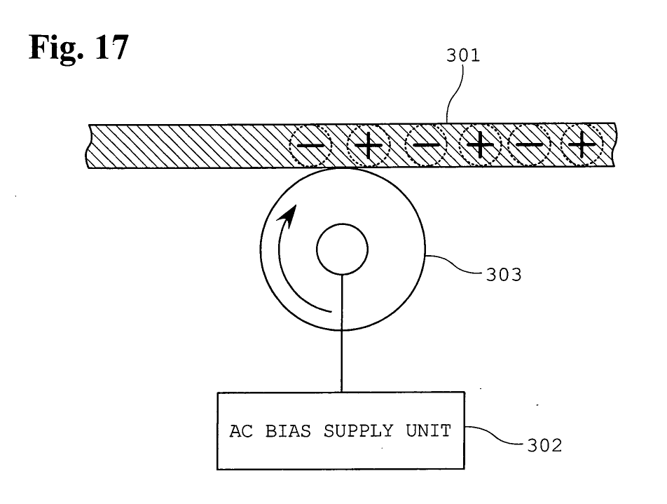

### BEST MODE FOR CARRYING OUT THE INVENTION

A sheet transporting device 1 of an electrostatic adsorption type according to an embodiment of the present invention and an image forming apparatus 2 equipped with this device are described in detail with reference to the drawings.

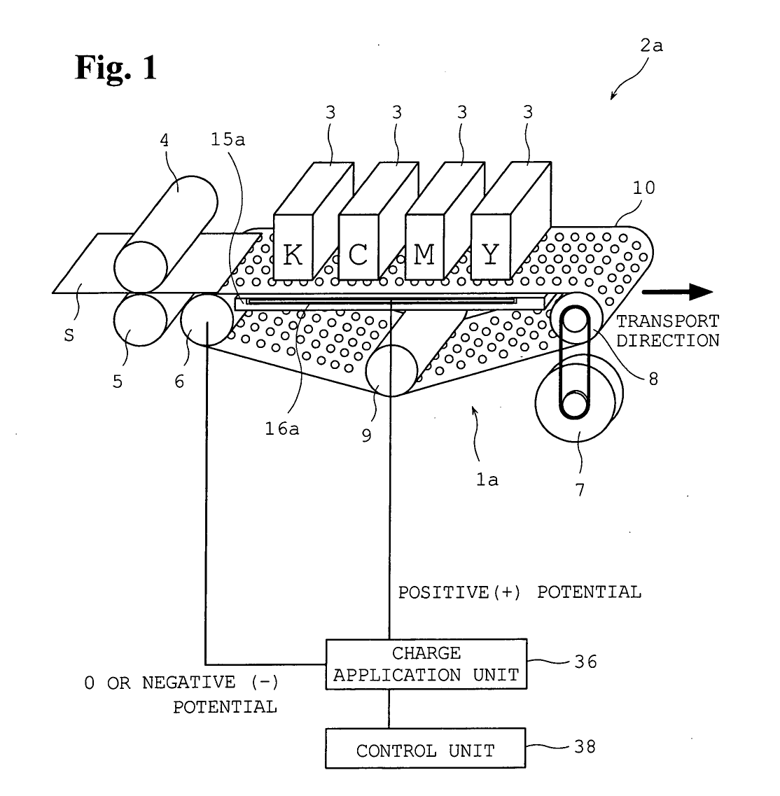

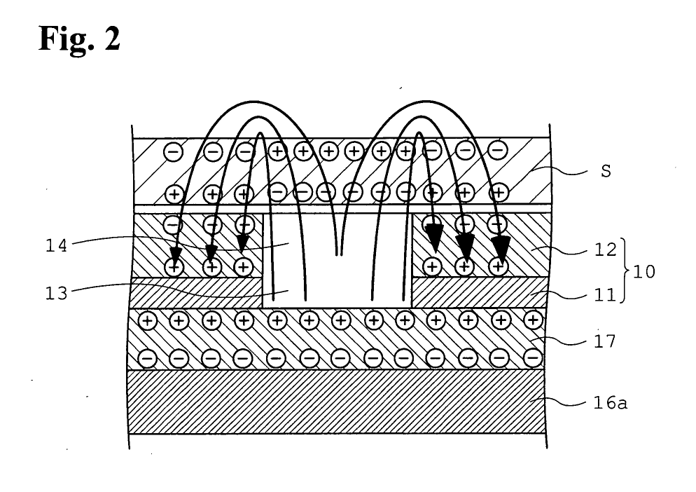

### 1. First Embodiment (First Example, See FIG. 1 and FIG. 2)

As is illustrated in FIG. 1, an image forming apparatus 2a of a first example is configured such that plural print heads 3 having different colors of inks are disposed facing down, spaced at certain intervals along a transport direction of a sheet S denoted by an arrow, and can jet ink droplets toward the sheet that is transported thereunder. In the example shown, four print heads jetting inks of four colors, C (cyan), K (black), M (magenta), and Y (yellow), respectively, are placed.

Directly under these print heads 3, a sheet transporting device 1a for transporting a sheet S along the print heads is disposed. Before the print heads 3 in the transport direction, first, a registration roller 4 and a driven roller 5 are provided adjacent to a paper feed mechanism which is not shown to feed a sheet S to the sheet transporting device 1a in the following stage.

The sheet transporting device 1a is configured such that an endless conveyor belt 10 is placed in a tense state on a driven roller 6 positioned upstream in the transport direction, a driving roller 8 provided downstream in the transport direction and interlocked and linked to a drive source 7, and a tension roller 9 disposed in a lower position in the middle between the driven roller 6 and the driving roller 8, and the conveyor belt 10 can be made to move circulatively in the transport direction by the driving roller 8 with an adequate tension being given to the conveyor belt 10 by the tension roller 9 urged downward. Of the conveyor belt 10 moving placed in a tense state on these rollers 6, 8, 9, the part moving horizontally in close proximity to the print heads becomes a transport path of a sheet S.

As is illustrated in FIG. 2, the conveyor belt 10 has a double-layer structure in which an inner portion (one side which comes in contact with the driven roller 6) includes a conductor 11 and a dielectric layer 12 is formed in an outer portion (the other side facing the print heads 3). The dielectric 12 is a material that is dielectric rather than conductive and resistive to DC current; for example, plastics and the like.

In the conductor 11 and the dielectric layer 12, plural continuously pierced circular holes with equal inside diameters are formed, spaced at a suitable interval. As will be described later, these through holes are formed to produce an electric field at and around a sheet S on the conveyor belt 10. Here, for convenience, a hole in the conductor 11 is referred to as a through hole 13, and a hole in the dielectric layer 12 communicating with the through hole 13 is referred to as an opening 14.

At least the peripheral surface of the above-mentioned driven roller 6 is conductive and 0 or a negative potential is applied to the peripheral surface by an voltage application unit 36 controlled by a control unit 38, thus making the conductor 11 of the conveyor belt 10 brought in metallic contact with the peripheral surface being at 0 (ground) or a negative potential. That is, the conveyor belt 10 of the first example is a movable electrode having 0 or a negative potential.

Underneath the above conveyor belt 10 lying in the transport path of a sheet S, a platen base 15a of a rectangular plate shape which supports the conveyor belt 10 is installed. This platen base 15a includes an insulating body in which a fixed electrode 16a is embedded. The fixed electrode 16a is a monolithic flat plate electrode which is connected to the above-mentioned charge applying unit 36 and to which a positive potential is applied. The fixed electrode 16a is disposed under the print heads 3 so as to occupy an area including the above four print heads 3 in a planar view. On the surface (the side facing the conveyor belt 10) of the fixed electrode 16a, a dielectric layer 17 is provided to prevent a short circuit due to contact with the above conveyor belt 10 moving along the surface.

According to the above-described configuration, as can be seen in FIG. 2 which explains the principle of adsorption of paper, the dielectric layer 17 is polarized by the fixed electrode 16a being at a positive potential and the surface thereof comes to have a positive potential. Hence, electrical flux lines from the side of the fixed electrode 16a pass through the through hole (through hole 13 and opening 14) of the conveyor belt 10 right above the fixed electrode 16a and go above the conveyor belt 10. The electrical flux lines penetrate from downward and polarize a sheet S placed on the surface of the conveyor belt 10, then loop back downward and penetrate from upward the sheet in the vicinity of the hole of the conveyor belt 10, polarizing it to opposite potentials, and further arrive at and polarize the dielectric layer 12 of the conveyor belt 10.

As a result, as can be seen in FIG. 2, positive and negative charges arise at the upper and under sides of each of the sheet S and the dielectric layer 12 such that the upper and under sides are charged oppositely to each other. Hence, the sheet S is electrostatically adsorbed to the dielectric layer 12 of the conveyor belt 10 in the through hole 13 portion and its vicinity of the conveyor belt 10 lying in the region adjacent to the fixed electrode 16a.

That is, an adsorption region that is able to adsorb the sheet S within the conveyor belt 10 only corresponds to the area having substantially the same form and extent as the fixed electrode 16a, lying right above the fixed electrode 16a. Therefore, this adsorption region will be produced in place right above the fixed electrode 16a in the conveyor belt 10 passing right above the fixed electrode 16a.

Accordingly, after feeding a sheet S to the conveyor belt 10 driven by the driving roller 8, when transporting the sheet S in the transport direction, while adsorbing and retaining the sheet S on the conveyor belt 10, a process jets ink droplets of each color to the sheet S at proper timing in accordance with speed of the transportation and deposits the ink drops, and can form a desired color image on the sheet.

In this way, according to the image forming apparatus 2a equipped with the sheet transporting device 1a of the first example, because of a simple structure in which the conveyor belt 10 which is the movable electrode at 0 or a negative potential moves with respect to the fixed electrode 16a at a positive potential, the inventive device is advantageous in terms of assembly workability and manufacturing cost in comparison with the prior-art sheet transporting device 1 of electrostatic adsorption type using comb-shaped electrodes and the like. Positive and negative electrodes are disposed in a vertical relationship and it is easy to set a gap more easily and precisely between two electrodes that determines adsorptive power.

The fixed electrode 16a which is a monolithic flat plate electrode is disposed under the plural print heads 3 and the conveyor belt 10 on which a sheet S was adsorbed moves while maintaining the state of adhesion to the fixed electrode 16a when it is under the print heads 3 and transports the sheet. Thus, a distance between the print heads and the sheet can be kept constant in the extent of the fixed electrode 16a in which the print heads 3 are disposed, and thereby print quality is improved.

Two positive and negative electrodes are separate; one is the fixed electrode 16a and the other is the conveyor belt 10 as the movable electrode. Thus, the inventive device is free from such disadvantage, as in the prior-art electrostatic transporting device with the comb-shaped electrodes charged positively and negatively alternately; i.e., the positively or negatively charged portions of the conveyor belt 10 polarized according to the potentials of the comb-shaped electrodes come to instantaneously counteract the negative or positive potential of the adjacent comb-shaped electrode being at an opposite potential when the conveyor belt moves, thus causing resistance to transportation. The inventive device is able to transport a sheet S by smooth operation avoiding intermittent transportation and, therefore, good print quality can be achieved.

Furthermore, in comparison with the prior-art transporting device of electrostatic adsorption type wherein electrodes are embedded in the conveyor belt 10, the thickness of the conveyor belt 10 itself in the inventive device is smaller and the belt surface has less irregularity. So, it is possible to reduce thickness variation and variation in the speed of transportation and, in this respect, to achieve good print quality.

In the first example, since the dielectric layer 12 is provided on the surface of the conveyor belt 10, the inventive device is safe, as it can prevent an electric shock accident that may happen as a user accidentally touches the conductor 11 of the conveyor belt 10 during use or checking. Even in the absence of the dielectric layer 12 in the conveyor belt 10, since, in the through hole portion of the conveyor belt 10, a sheet S and the dielectric layer 17, which faces the sheet S, of the fixed electrode 16a are polarized to potentials opposite to each other, sufficient electrostatic adsorptive power is ensured and the sheet S can be adsorbed to the conveyor belt 10.

Although a through hole (through hole 13 and opening 14) is pierced in the conveyor belt 10 in the present embodiment, the hole portion may be made of a conductive polymer such as polyacetylene, polyparaphenylene, polyaniline, polythiophene, polypyrrole, polyacene, and polyparaphenylene-vinylene.

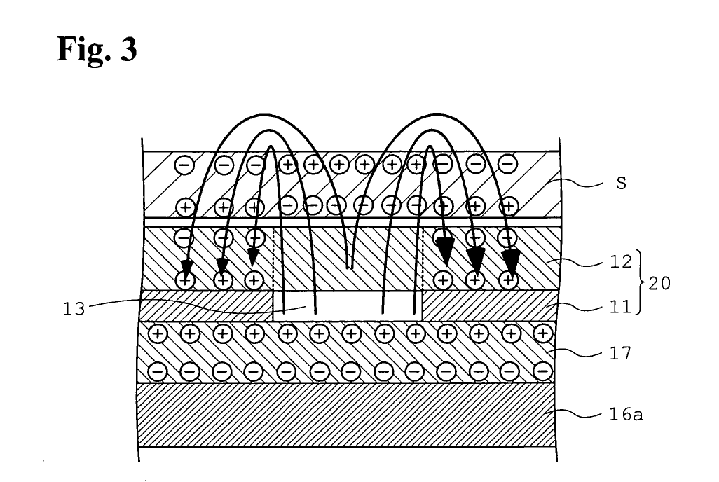

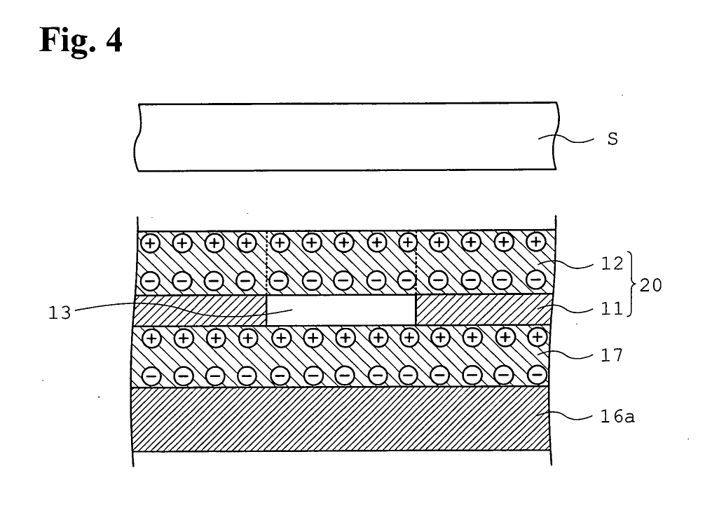

### 2. Second Embodiment (Second Example, See FIG. 3 and FIG. 4)

A sheet transporting device of a second example is installed in the same image forming apparatus as the image forming apparatus 2a of the first example and the fundamental principle of electrostatic adsorption is also the same as in the first example. Therefore, the following description focuses on the structure of a conveyor belt 20 which is different from that of the first example, omitting the description of the image forming apparatus and the description of the common part of the electrostatic adsorption mechanism.

In the sheet transporting device of the first example, the through hole 13 in the conductor 11 communicates with the opening 14 in the dielectric layer 12 wherever holes are bored; that is, all holes in the conveyor belt 10 are completely pierced through holes. A dissimilar point of the second example is as follows: in some holes, there is no opening in the dielectric layer 12 formed on top of the through hole 13 in the conductor 11, as is illustrated in FIG. 3. That is, a part of the holes in the conveyor belt 10 includes completely pierced through holes, whereas the remaining part includes through holes 13 covered with the dielectric layer without the opening 14.

In this way, according to the image forming apparatus equipped with the sheet transporting device of the second example, in a section of the conveyor belt 20 where the through hole 13 communicates with the opening of the dielectric layer 12 (holes in the conveyor belt 20 are completely pierced vertically over the belt width) a sheet S is adsorbed onto the conveyor belt 20 by the same principle as explained in the first example.

On the other hand, in a section of the conveyor belt 20, where the through hole 13 is closed by the dielectric layer 12 (holes in the conveyor belt 10 are not pierced vertically over the belt width), a phenomenon that electrostatic adsorptive power decreases with time passage is observed.

As can be seen in FIG. 3, first, at a stage in which conveyor belt 20 comes to the position above the fixed electrode 16a and the adsorption region arises in the conveyor belt 20, the dielectric layer 17 is polarized by the fixed electrode 16a being at a positive potential and the surface of the dielectric layer 17 becomes to have a positive potential. Then, electrical flux lines from the side of the fixed electrode 16a pass through the through hole 13 and the dielectric layer 12 of the conveyor belt 20 right above the fixed electrode 16a and go above the conveyor belt 20. The electrical flux lines penetrate from downward and polarize a sheet S placed on the surface of the conveyor belt 20, then loop back downward and penetrate from upward the sheet in the vicinity of the through hole 13 of the conveyor belt 20, polarizing it to opposite potentials, and further arrive at and polarize the dielectric layer 12 of the conveyor belt 20.

As a result, as can be seen in FIG. 3, in the surrounding area of the through hole 13 of the conveyor belt 20, positive and negative charges arise at the upper and under sides of each of the sheet S and the dielectric layer 12 such that the upper and under sides are charged oppositely to each other. Hence, the sheet S is electrostatically adsorbed to the dielectric layer 12 of the conveyor belt 20 in the through hole 13 portion and its vicinity of the conveyor belt 20 lying in the region adjacent to the fixed electrode 16a.

However, as is illustrated in FIG. 4, even if the adsorption region of the conveyor belt 20 is in the position above the fixed electrode 16a, charges are stored over time into the through hole 13 closed portion (the portion right above the through hole 13) and the potential of this portion becomes equivalent to that of the surrounding dielectric layer 12 of the conveyor belt 20. This shuts off the electrical flux lines penetrating the sheet S, the upper and under sides of the sheet S become uncharged, resulting in a decrease in the power of adsorbing the sheet S to the dielectric layer 12, and eventually the adsorptive power is lost.

Accordingly, completely pierced through holes and through holes 13 only in the conductor 11 covered with the dielectric layer 12 without the opening, which are not pierced, may be formed so as to be distributed appropriately in the conveyor belt 20. Thereby, in the adsorption region generated in the conveyor belt 20, sections where adsorptive power is maintained and sections where adsorptive power attenuates over time may be distributed arbitrarily. The strength of the adsorptive power and a way of its attenuation over time can be set arbitrarily.

Therefore, appropriate setting of distribution of the above two types of holes in the conveyor belt 20 enables the following: in the transportation of a sheet S on the conveyor belt 20 using electrostatic adsorption, retaining the sheet S in the adsorption region of the conveyor belt 20 securely with required adsorptive power at the start of adsorption of the sheet S; and attenuation of excess adsorptive power over time, while keeping the adsorptive power required to transport the sheet during the transportation of the sheet S. Thus, it is possible to improve image reproducibility, eliminating to some degree a disadvantage in which the directions of ink droplets jetted toward the sheet from the print heads are deflected by the influence of the charges. When the sheet S is going to be ejected, coming to a position out of the last print head 3 in the transport direction by the movement of the conveyor belt 20, the power of adsorbing the rear end of the sheet S readily attenuates, which enables smooth operation for paper ejection from the conveyor belt 20 to allow the paper to drop.

In this way, according to the image forming apparatus equipped with the sheet transporting device of the second example, the inventive device having a simple structure decreases the influence of electric fields on the fall of ink droplets, improves image reproducibility, improves sheet separation when a sheet is ejected (drop off the conveyor belt 20), and improves the alignment of paper sheets after being ejected.

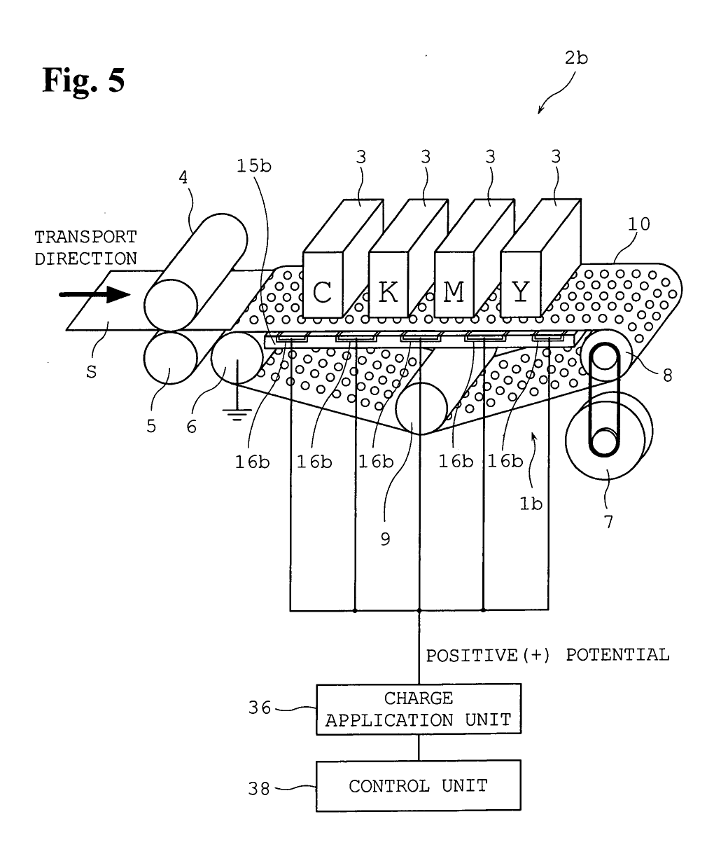

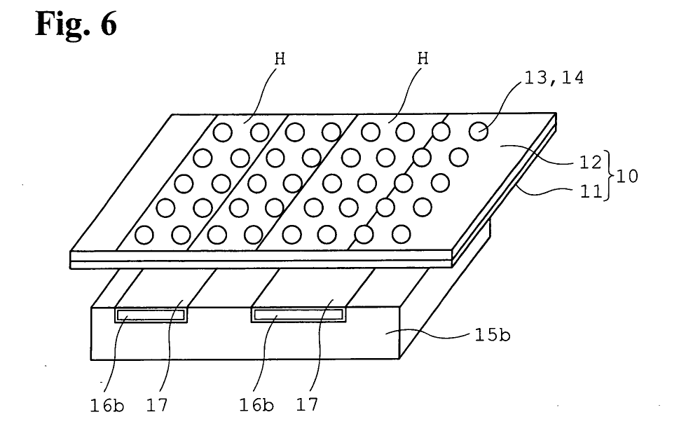

### 3. Third Embodiment (Third Example, See FIG. 5 and FIG. 6)

A sheet transporting device 1b of a third example is installed in the same image forming apparatus 2b as the image forming apparatus 2a of the first example and the fundamental principle of electrostatic adsorption is the same as in the first example. Therefore, the following description focuses on the structure of a fixed electrode 16b which is different from that of the first example, omitting the description of the image forming apparatus 2b and the description of the common part of the electrostatic adsorption mechanism.

As is illustrated in FIG. 5, underneath the above conveyor belt 10 which is the transport path of a sheet S, a platen base 15b of a rectangular plate shape which supports the conveyor belt 10 is installed. This platen base 15b includes an insulating body in which plural fixed electrodes 16b (five electrodes in the third example) are embedded spaced at a given interval. These fixed electrodes 16b are connected to the charge applying unit 36 and to which a positive potential is applied. One of the fixed electrodes 16b is placed in a position not facing the above-mentioned print heads, i.e., the position before a print head 3 (C) located most upstream with respect to the transport direction, three of them are placed in three positions between each of the four print heads 3 (C, K, M, Y), and the remaining one is placed in a position after the print head 3 (Y) located most downstream with respect to the transport direction. On the surface (the side facing the conveyor belt 10) of the fixed electrodes 16b, a dielectric layer 17 is provided to prevent a short circuit due to contact with the above conveyor belt 10 moving along the surface.

According to the third example, as is illustrated in FIG. 6, an adsorption region H that is able to adsorb a sheet S within the conveyor belt 10 only corresponds to the area having substantially the same form and extent as each fixed electrode 16b, lying right above the fixed electrode 16b. Therefore, adsorption regions H will be produced in places right above the fixed electrodes 16b, spaced at substantially the same interval as for the fixed electrodes 16b, in the conveyor belt 10 passing right above each fixed electrode 16b.

According to the third example, substantially the same effect as the first example is obtained, but because of the divided structure of the fixed electrode 16b composed of plural electrodes which are spaced, the third example has an advantage that the transporting load is reduced compared with the first example, as the areas contacting and adhering to the moving belt 10, thus causing resistance, are smaller than the monolithic plate fixed electrode 16a.

Each of the print heads 3 is disposed out of the position of each of the fixed electrodes 16b and there is no fixed electrode 16b under each of the print heads 3. Because of the reduced possibility of a disadvantage in which ink droplets jetted downward from the print heads 3 are deflected in space by the electric fields of the fixed electrodes 16b, better image equality than the first example can be obtained.

Further, in this third example, if the conveyor belt is adapted such that through holes and non-through holes are distributed at a suitable ratio over the belt as described in the foregoing second example (FIG. 3 and FIG. 4), a charged sheet S is uncharged more quickly in the regions under the print heads 3 between each fixed electrode 16b. Hence, the disadvantage in which the directions of ink droplets jetted toward the sheet from the print heads 3 are deflected by the influence of the charges is eliminated more securely. When sheets are ejected, poor sheet alignment in the paper collector due to charged sheets S is reduced more securely.

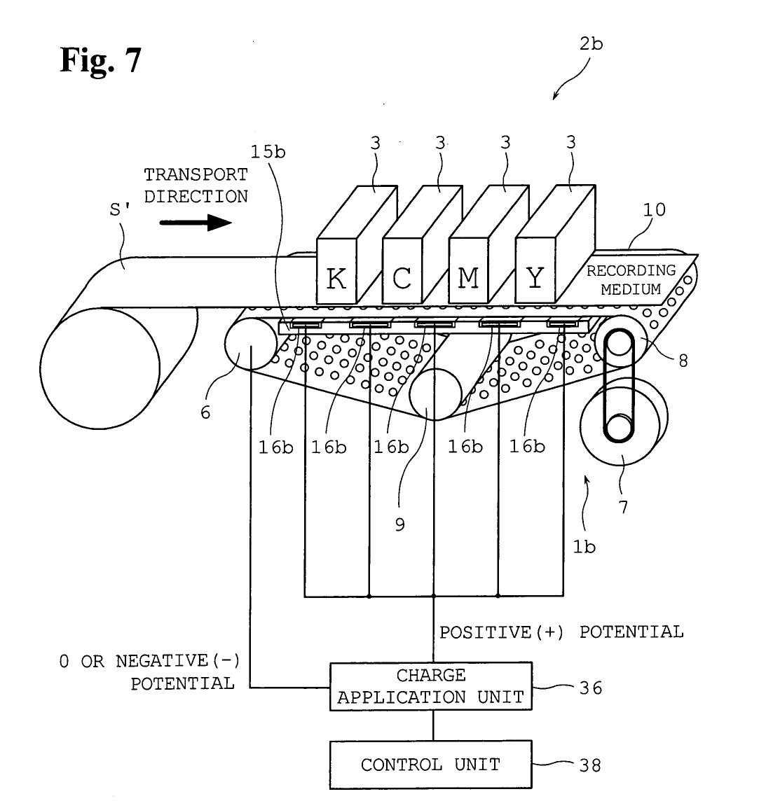

Then, FIG. 7 is an overall structural diagram of a modification example of the third example.

The structure of the image forming apparatus 2b having a sheet transporting device 1b of the present modification example differs from the third example in that the charge application unit 36 applies 0 or a negative potential to the driven roller 6 and that an image recording medium is a roll of sheet S′ instead of a sheet. Others are the same as the example 3. In this way, in an embodiment of the present invention, it is possible to continuously transport a rolled web of a sheet material and form a high-equality image, not only a sheet-like print medium such as printing paper and film. In FIG. 7, the registration roller 4 and the driven roller 5 are omitted.

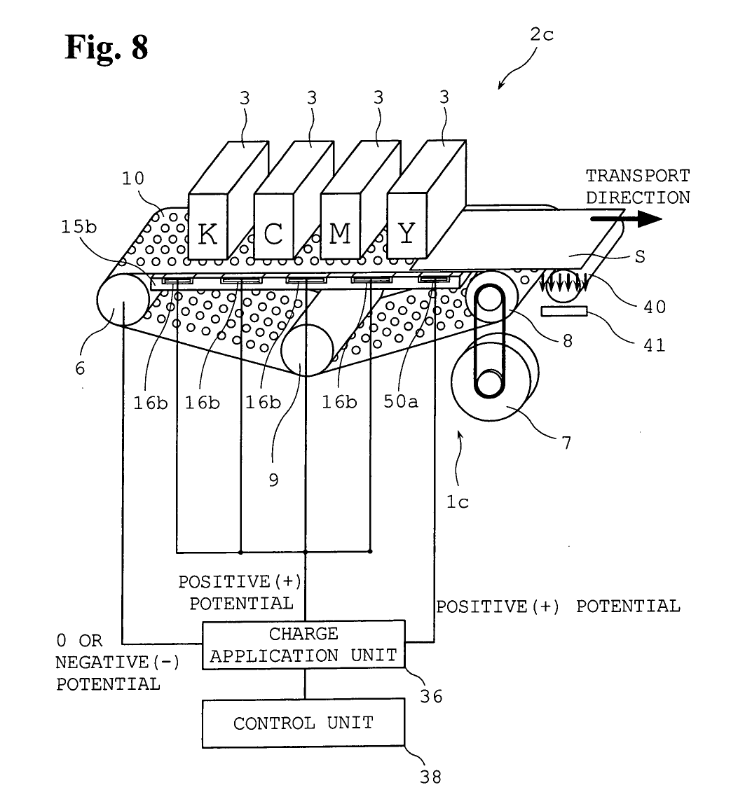

### 4. Fourth Embodiment (Fourth Example, See FIG. 8)

An image forming apparatus 2c equipped with a sheet transporting device 1c of a fourth embodiment is described.

In the description of the fourth embodiment, elements that are practically the same in function as those in the modification example of the third example (FIG. 7) are assigned the same references in FIG. 8 as used in FIG. 7 and their description is omitted appropriately. The following description focuses on elements relevant to features of the fourth example, unlike the modification example of the third example (FIG. 7).

As is illustrated in FIG. 8, an eject roller 40 which ejects a sheet S having an image formed thereon downstream, while adsorbing the sheet, is disposed aside downstream of the conveyor belt 10 in the transport direction of a sheet S. This eject roller 40 rotates at a greater speed than the above conveyor belt 10 to facilitate paper ejection and is always driven during image formation by the print heads 3 on a sheet S being transported. The adsorptive power of the eject roller 40 is provided by an air suction fan 41 installed underneath the eject roller 40 and the adsorptive power by the air suction (wind) is larger than the adsorptive power by the conveyor belt 10 only.

Here, the sheet transporting device 1c of the present example has a smaller dimension in the sheet transport direction including the eject roller 40 and features a compact structure in which the space between the print head 3 (Y) located most downstream with respect to the sheet transport direction and the above eject roller 40 is shorter than the length of a sheet S in the transport direction. The compact structure is preferable in various respects. However, when the most downstream print head 3 (Y) is forming an image on the rear end portion of a sheet S, the forward end of the sheet S is caught on the eject roller 40 which is constantly running and pulled by the driving force of the roller. If no measures are taken, the pull of the sheet S by the eject roller 40 during image formation by the most downstream print head 3 (Y) may cause misregistration of colors.

However, the sheet transporting device 1c of the present example is configured as follows. An electrostatic adsorptive electrode 50a is provided between the print head 3 (Y) located most downstream with respect to the sheet S transport direction and the eject roller 40. When a sheet S is positioned with its extension on both the most downstream print head 3 (Y) and the eject roller 40, the sheet S is stopped by this electrostatic adsorptive electrode 50a to avoid misregistration of colors by the pull of the sheet S toward the ejection direction.

This electrostatic adsorptive electrode 50a is installed along with the above-mentioned fixed electrodes in the platen base 15b, but this electrode is structurally and electrically independent from the fixed electrodes 16. A positive potential higher than the potentials of the fixed electrodes 16 is applied to this electrode by the charge application unit 36. Thereby, this electrode produces an electric field stronger than the electric fields produced by the fixed electrodes 16 to enhance the adsorptive power to the conveyor belt 10 in the rear end portion of a sheet S during image formation.

According to the above-described configuration, when the driving roller 8 is rotated by the drive source 7 and the conveyor belt 10 is moved circulatively in the transport direction while the charge application unit 36 is appropriately controlled by the control unit 38, a sheet S electrostatically adsorbed on the conveyor belt 10 by the electric fields generated by the fixed electrodes 16b is transported under the print heads 3 along each of the print heads 3.

By driving each of the print heads 3 in synchronization with transportation of the sheet S by the conveyor belt 10, a desired image can be formed on the sheet S. Here, when the rear end portion of the sheet S is undergoing image formation by the most downstream print head 3 (Y), the forward end of the sheet S is already caught on the eject roller 40 and pulled toward the ejection direction at a greater speed than the conveyor belt 10, while being adsorbed to the eject roller 40 by the adsorptive power of the air suction fan 41.

However, the rear end portion of the sheet S is influenced by the electric field produced by the electrostatic adsorptive electrode 50a installed adjacent to the most downstream print head 3 (Y) in the sheet transport direction and this electric field increases the electrostatic adsorptive power to the surface of the conveyor belt 10. Hence, the sheet S does not shift toward the ejection direction, pulled by the eject roller 40, and there is no possibility of a disadvantage of misregistration of colors occurring in the most downstream print head 3 (Y). In this way, while image formation on a sheet S is performed by the print head 3, the adsorptive power of the conveyor belt 10 is always greater than the adsorptive power of the eject roller 40.

When image formation by the print head 3 finishes, application of a positive potential to the electrostatic adsorptive electrode 50a by the charge application unit 36 is stopped, the corresponding electric field is lost, and the strong electrostatic adsorptive power is lost. Then, the adsorptive power of the eject roller 40 becomes even greater than the adsorptive power of the conveyor belt 10 and the sheet S having the finished image formed thereon is rapidly accelerated and ejected by the eject roller 40.

The adsorptive power adsorbing a sheet S produced on the conveyor belt 10 by the electrostatic adsorptive electrode 50a may always be greater than the adsorptive power of the eject roller 40, alternatively, may become greater only at timing when a sheet S is positioned with its extension on the most downstream print head 3 (Y) and the eject roller 40.

Control of the electrostatic adsorptive electrode 50a may be performed as follows. The control unit 38 and the charge application unit 36 may detect that a sheet S leaves the most downstream print head 3 (Y) by prediction from a detection signal from, for example, a paper forward end detecting sensor and the number of pulses of an encoder and change the adsorptive power of the electrostatic adsorptive electrode 50a.

In prior art, the space between the last print head 3 and the eject roller 40 needs to be longer than the length of a sheet S so that the speed of transportation of a sheet during image formation is not influenced by the speed of the eject roller 40 and this makes the size of the device larger. Conversely, in a case that a smaller device is desired, the ejection speed of the eject roller 40 is set lower than the speed of the conveyor belt 35 to avoid misregistration of colors, which might cause paper jam during ejection or misalignment of ejected sheets.

However, according to the configuration of the fourth example, the provision of the electrostatic adsorptive electrode 50a between the last print head 3 and the eject roller 40 enables compactness in the dimension in the sheet S transport direction without decreasing the ejection speed of the eject roller 40.

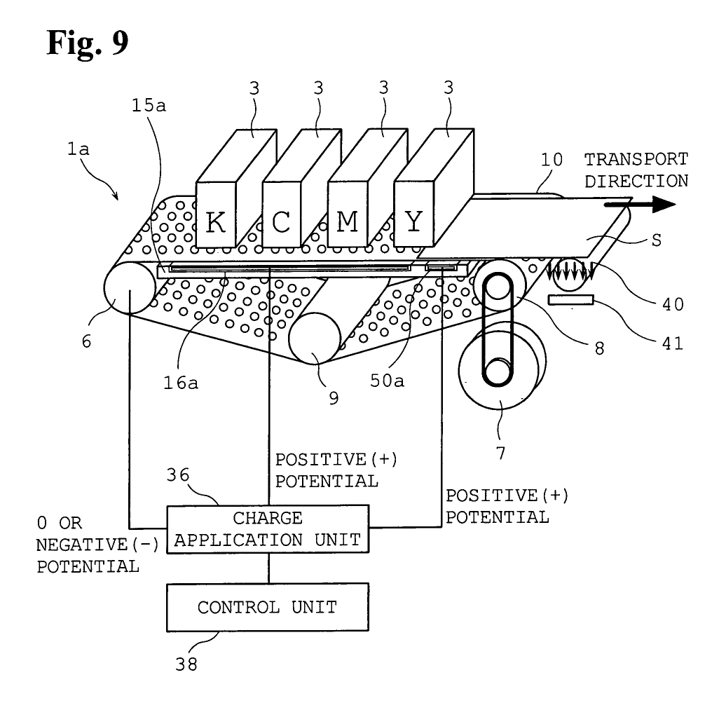

### 5. Fifth Embodiment (Fifth Example, See FIG. 9)

FIG. 9 shows a combination of the sheet transporting device 1a (see FIG. 1) having the fixed electrode 16a in the first example and the electrostatic adsorptive electrode 50a of the sheet transporting device 1c (see FIG. 8) in the fourth example. In FIG. 9, components having corresponding functions and names are assigned the foregoing references and the foregoing descriptions (about structure, function, effect, etc.) should be referred to.

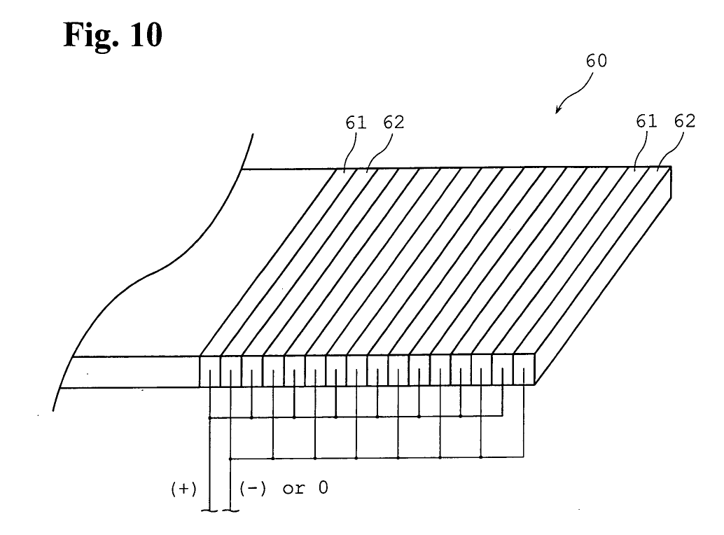

### 6. Sixth Embodiment (Sixth Example, See FIG. 10)

A sheet transporting device of a sixth example includes an electrostatic adsorptive electrode 50 whose structure only differs from the fourth example and the fifth example and other components are the same. Therefore, only the electrostatic adsorptive electrode section is shown and described.

The electrostatic adsorptive electrode 50a in the fourth example and the fifth example is a single rectangular electrode installed under the conveyor belt 35 and a positive potential is applied to it. An electrostatic adsorptive electrode 60 of the sixth example is a comb-shaped electrode installed in approximately the same position as the installation position of the electrostatic adsorptive electrode 50a in the fourth and fifth examples. Of this interdigital electrode, comb teeth 61, 62 are connected to a positive or negative (or 0) potential alternately and insulated from each other. In the present example as well, the same effect as provided by the fourth example and the fifth example can be obtained.

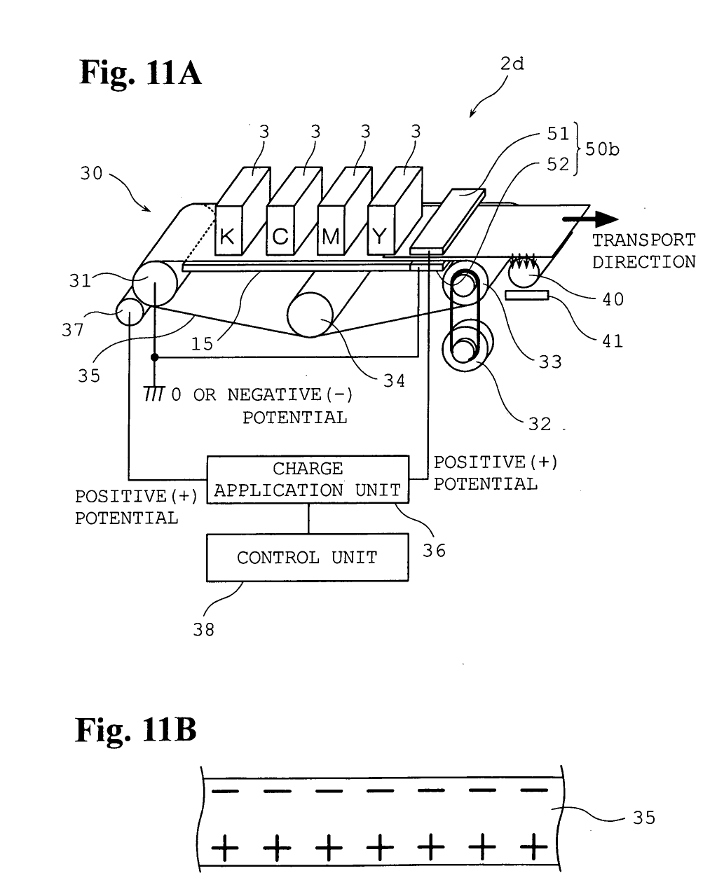

### 7. Seventh Embodiment (Seventh Example, See FIG. 11)

In the image forming apparatus of the fourth through sixth examples, the art of the sheet transporting device configured such that the adsorptive power adsorbing the read end of a sheet is made stronger than the adsorptive power of the eject roller to avoid misregistration of colors due to the pull of the sheet toward the ejection direction, can be applied effectively in a commonly used electrostatic transporting device as described, for example, in the “Background Art” section. Thus, in a seventh example, a description is provided as to an example where, in an image forming apparatus 2d having an electrostatic transporting device of a charging roller type, an electrostatic adsorptive electrode adsorbing the rear end of a sheet with stronger adsorptive power than the adsorptive power of the eject roller is provided.

In this sheet transporting device 30, an endless conveyor belt 35 made of a covering dielectric is placed in a tense state on a driven roller 31 positioned upstream in the transport direction and connected to 0 or a negative potential, a driving roller 33 provided downstream in the transport direction and interlocked and linked to a drive source 32, and a tension roller 34 disposed in a lower position in the middle between the driven roller 31 and the driving roller 33.

Further, a charging roller 37 connected to the charge application unit 36 and having a positive potential is installed on the outside of the conveyor belt 35 placed on the driven roller 31 to nip the conveyor belt 35 between it and the above driven roller 31 connected to 0 or a negative potential and having an opposite polarity. The charge application unit 36 is connected to the control unit 38 and controlled by the control unit 38 so that it can supply a desired positive potential to an electrode member connected to it.

The above charging roller 37 being at a positive potential is an electrode member to produce an electric field surrounding the conveyor belt 35 in conjunction with the above driven roller 31 being at 0 or a negative potential of an opposite polarity and polarize the conveyor belt 35. The core of the charging roller 37 is made of a metal and its surface is made of a rubber material or the like with a resistivity, for example, on the order of 1×10¹²Ω generating friction required for transportation.

The conveyor belt 35 is made of the covering dielectric as already stated. The covering dielectric is a material that is charged itself and is able to adsorb a charged object (sheet S) being transported. In the third example, polyimide film on the order of 1×10¹² to 1×10¹⁴Ω is used.

Therefore, as is illustrated in FIG. 11(b), the surface (upper side) of the conveyor belt 35 is charged negatively and its rear side (underside) is charged positively in the transport path adsorbing a sheet S (the upper portion of the circulating belt). When a sheet S such as printing paper which is a medium on which an image is printed is fed onto the conveyor belt 35, the side (underside) of the sheet contacting the conveyor belt 35 is charged positively and its surface (upper side) is charged negatively, thus polarized, and electrostatically adsorbed to the conveyor belt 35.

Hence, when the driving roller 33 is rotated by the drive source 32 and the conveyor belt 35 is moved circulatively in the transport direction, adequate tension being exerted on the conveyor belt 35 by the tension roller 34 urged downward, while the charge application unit 36 is appropriately controlled by the control unit 38, a sheet S electrostatically adsorbed on the conveyor belt 35 can be transported under the print heads 3 along each print head 3. That is, of the conveyor belt 35 moving placed in a tense state on these rollers, the part moving horizontally in close proximity to the print heads, becomes the transport path of a sheet S.

Underneath the above conveyor belt 35 lying in the transport path of a sheet S, a platen base 15 of a rectangular plate shape which supports the conveyor belt 35 is installed. This platen base 15 includes an insulating body and serves to support the conveyor belt 35.

An eject roller 40 which ejects a sheet S having an image formed thereon downstream, while adsorbing the sheet, is disposed aside downstream of the conveyor belt 35 in the transport direction of a sheet S. This eject roller 40 rotates at a greater speed than the above conveyor belt 35 to facilitate paper ejection and is always driven during image formation by the print heads 3 on a sheet S being transported. The adsorptive power of the eject roller 40 is provided by an air suction fan 41 installed underneath the eject roller 40 and the adsorptive power by the air suction (wind) is larger than the adsorptive power by the conveyor belt 35 only.

Here, the sheet transporting device 30 of the present example has a smaller dimension in the sheet transport direction including the eject roller 40 and features a compact structure in which the space between the print head 3 (Y) located most downstream with respect to the sheet transport direction and the above eject roller 40 is shorter than the length of a sheet S in the transport direction. The compact structure is preferable in various respects. However, when the most downstream print head 3 (Y) is forming an image on the rear end portion of a sheet S, the forward end of the sheet S is caught on the eject roller 40 which is constantly running and pulled by the driving force of the roller. If no measures are taken, the pull of the sheet S by the eject roller 40 during image formation by the most downstream print head 3 (Y) may cause misregistration of colors.

However, the sheet transporting device 30 of the present example is configured as follows. An electrostatic adsorptive electrode 50b is provided between the print head 3 (Y) located most downstream with respect to the sheet S transport direction and the eject roller 40. When a sheet S is positioned with its extension on both the most downstream print head 3 (Y) and the eject roller 40, the sheet S is stopped by this electrostatic adsorptive electrode 50a to avoid misregistration of colors by the pull of the sheet S toward the ejection direction.

This electrostatic adsorptive electrode 50b includes a positive electrode plate 51 (upper side) and a negative electrode plate 52 (underside) in up and down positions, designed not to contact the conveyer belt 35, sandwiching the conveyor belt 35 between the most downstream print head 3 (Y) and the eject roller 40. An electric field produced between both electrode plates 51, 52 enhances the adsorptive power adsorbing a sheet S to the conveyor belt 35.

According to the above-described configuration, when the driving roller 33 is rotated by the drive source 32 and the conveyor belt 35 is moved circulatively in the transport direction, while the charge application unit 36 is appropriately controlled by the control unit 38, a sheet S electrostatically adsorbed on the conveyor belt 35 is transported under the print heads 3 along each print head 3.

By driving each print head 3 in synchronization with transportation of the sheet S by the conveyor belt 10, a desired image can be formed on the sheet S. Here, when the rear end portion of the sheet S is undergoing image formation by the most downstream print head 3 (Y), the forward end of the sheet S is already caught on the eject roller 40 and pulled toward the ejection direction at a greater speed than the conveyor belt 10, while being adsorbed to the eject roller 40 by the adsorptive power of the roller.

However, around the middle portion of the sheet S is influenced by the electric field produced by the electrostatic adsorptive electrode 50b between the most downstream print head 3 (Y) and the eject roller 40, and this electric field increases the electrostatic adsorptive power to the surface of the conveyor belt 35. Hence, the sheet S does not shift toward the ejection direction, pulled by the eject roller 40, and there is no possibility of a disadvantage of misregistration of colors occurring in the most downstream print head 3 (Y). In this way, while image formation on a sheet S is performed by the print head 3, the adsorptive power of the conveyor belt 35 is always greater than the adsorptive power of the eject roller 40.

When image formation by the print head 3 finishes, application of a positive potential to the positive electrode plate 51 of the electrostatic adsorptive electrode 50b is stopped, the corresponding electric field is lost, and the electrostatic adsorptive power is no longer enhanced. Then, the adsorptive power of the eject roller 40 becomes even greater than the adsorptive power of the conveyor belt 35 and the sheet S having the finished image formed thereon is rapidly accelerated and ejected by the eject roller 40.

The adsorptive power adsorbing a sheet S on the conveyor belt 35 by the electrostatic adsorptive electrode 50b may always be greater than the adsorptive power of the eject roller 40, alternatively, may become greater only at timing when a sheet S is positioned with its extension on the most downstream print head 3 (Y) and the eject roller 40.

Control of the electrostatic adsorptive electrode 50b may be performed as follows. The control unit 38 and the charge application unit 36 may detect that a sheet S leaves the most downstream print head 3 (Y) by prediction from a detection signal from, for example, a paper forward end detecting sensor and the number of pulses of an encoder and change the adsorptive power of the electrostatic adsorptive electrode 50b.

In prior art, the space between the last print head 3 and the eject roller 40 needs to be longer than the length of a sheet S so that the speed of transportation of a sheet during image formation is not influenced by the speed of the eject roller 40 and this makes the size of the device larger. Conversely, in a case that a smaller device is desired, the ejection speed of the eject roller 40 is set lower than the speed of the conveyor belt 35 to avoid misregistration of colors, which might cause paper jam during ejection or misalignment of ejected sheets.

However, according to the configuration of the seventh example, the provision of the electrostatic adsorptive electrode 50b between the last print head 3 and the eject roller 40 enables compactness in the dimension in the sheet S transport direction without decreasing the ejection speed of the eject roller 40.

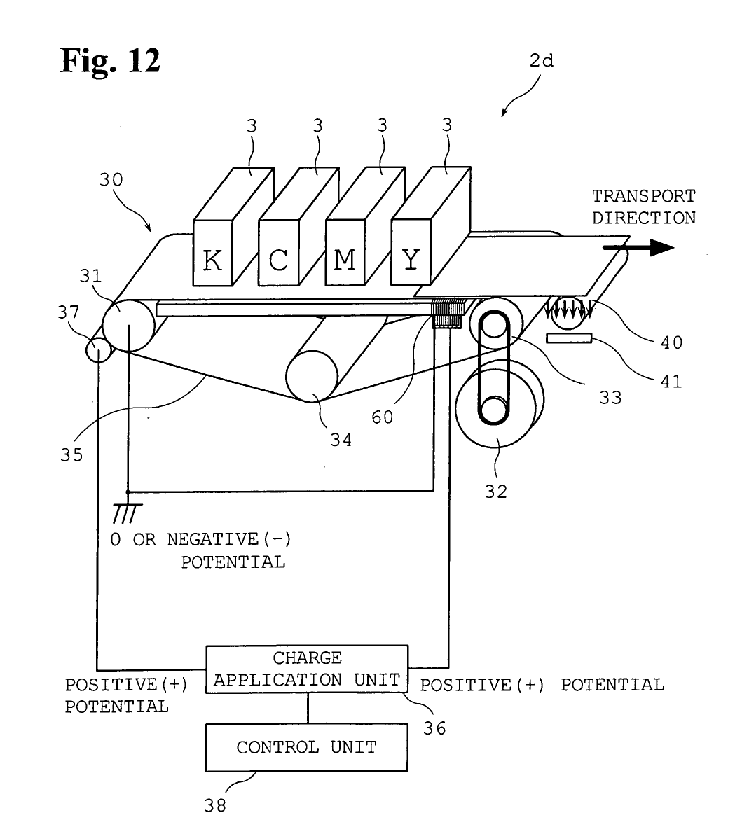

### 8. Eighth Embodiment (Eighth Example, See FIG. 12)

FIG. 12 shows an inventive device wherein the electrostatic adsorptive electrode 50b in the sheet transporting device 30 (see FIG. 11) of the seventh example is replaced by the electrostatic adsorptive electrode 60 in the sixth example (see FIG. 10). In FIG. 12, components having corresponding functions and names are assigned the foregoing references and the foregoing descriptions (about structure, function, effect, etc.) should be referred to.

The sheet transporting device of each embodiment described hereinbefore is used as the means for transporting sheets in the image forming apparatus equipped with print heads which jet ink onto the sheet and form an image. However, the present invention is not always applied only to such an ink jet type image forming apparatus. For example, the invention is applicable as sheet transporting means in a screen printing apparatus and also applicable in an image forming apparatus or a printing apparatus using other image forming principles. Furthermore, the invention is not limited to the sheet transporting means of the image forming apparatus and can be utilized effectively as means enabling stable transportation of sheets for various industrial applications.

Reference designations of the elements of the present embodiments used in the specification with reference to the drawings are listed below.

1a, 1b, 1c, 30 . . . Sheet transporting device

2a, 2b, 2c, 2d . . . Image forming apparatus

3 . . . Print head

10, 20 . . . Conveyor belt

11 . . . Conductor

12 . . . Dielectric layer of conveyor belt

13 . . . Through hole in the conductor

14 . . . Opening in the dielectric layer of conveyor belt

16a, 16b . . . Fixed electrode

17 . . . Dielectric layer of fixed electrode

40 . . . Eject roller

50a, 50b, 60 . . . Electrostatic adsorptive electrode

51 . . . Positive electrode plate

52 . . . Negative electrode plate

S, S′ . . . Sheet

1. A sheet transporting device for transportation of a sheet, comprising:
a fixed electrode having a first potential applied thereto and provided with a dielectric layer on its surface facing a transportation path of the sheet; and
a conveyor belt driven circulatively relative to the dielectric layer of the fixed electrode in a sheet transport direction and including a conductor having a second potential applied thereto and having a plurality of through holes formed therein, allowing electrical flux lines from the fixed electrode to pass through, wherein the sheet is electrostatically adsorbed to a belt surface opposite to the fixed electrode.

2. A sheet transporting device provided in an image forming apparatus forming an image on a sheet by ink jetting onto the sheet from a plurality of print heads disposed, spaced at an interval, for transportation of the sheet along the print heads, comprising:
a fixed electrode disposed underneath the print heads, having a first potential applied thereto, and provided with a dielectric layer on its surface facing the print heads; and
a conveyor belt driven circulatively relative to the dielectric layer of the fixed electrode in a sheet transport direction and including a conductor having a second potential applied thereto and having a plurality of through holes formed therein, allowing electrical flux lines from the fixed electrode to pass through, wherein the sheet is electrostatically adsorbed to a belt surface on the print head side.

3. The sheet transporting device according to claim 1, wherein the fixed electrode is divided into a plurality of elements arranged in the sheet transport direction.

4. The sheet transporting device according to claim 3, wherein the plurality of divisional elements of the fixed electrode are disposed in positions not corresponding to the positions of the print heads.

5. The sheet transporting device according to claim 3, wherein the conveyor belt is provided with a dielectric layer in its surface on which a sheet is placed and a plurality of openings, each communicating with each of the through holes, are formed in the dielectric layer.

6. The sheet transporting device according to claim 3, wherein the conveyor belt is provided with a dielectric layer in its surface on which a sheet is placed and a plurality of openings are formed in the dielectric layer to communicate with some of the plurality of through holes formed in the conveyor belt.

7. The sheet transporting device according to claim 3, comprising:
an eject roller installed aside downstream of the conveyor belt with respect to the sheet transport direction and ejecting a sheet having an image formed thereon downstream at a greater speed than a speed of the conveyor belt, while adsorbing the sheet; and
an electrostatic adsorptive electrode installed between one of the print heads located most downstream with respect to the sheet transport direction and the eject roller and producing electrostatic adsorptive power stronger than the adsorptive power of the eject roller when a sheet is positioned with its extension on both the print head located most downstream with respect to the sheet transport direction and the eject roller.

8. A sheet transporting device provided in an image forming apparatus forming an image on a sheet by ink jetting onto the sheet from print heads, the sheet transporting device comprising a conveyor belt for transportation of the sheet by moving along the print heads, while electrostatically adsorbing the sheet, and an eject roller installed aside downstream of the conveyor belt with respect to the sheet transport direction and ejecting the sheet having an image formed thereon downstream at a greater speed than a speed of the conveyor belt, while adsorbing the sheet,
wherein an electrostatic adsorptive electrode is installed between one of the print heads located most downstream with respect to the sheet transport direction and the eject roller to produce electrostatic adsorptive power stronger than the adsorptive power of the eject roller when a sheet is positioned with its extension on both the print head located most downstream with respect to the sheet transport direction and the eject roller.

9. The sheet transporting device according to claim 2, wherein the fixed electrode is divided into a plurality of elements arranged in the sheet transport direction.

10. The sheet transporting device according to claim 9, wherein the plurality of divisional elements of the fixed electrode are disposed in positions not corresponding to the positions of the print heads.

11. The sheet transporting device according to claim 9, wherein the conveyor belt is provided with a dielectric layer in its surface on which a sheet is placed and a plurality of openings, each communicating with each of the through holes, are formed in the dielectric layer.

12. The sheet transporting device according to claim 9, wherein the conveyor belt is provided with a dielectric layer in its surface on which a sheet is placed and a plurality of openings are formed in the dielectric layer to communicate with some of the plurality of through holes formed in the conveyor belt.

13. The sheet transporting device according to claim 9, comprising:
an eject roller installed aside downstream of the conveyor belt with respect to the sheet transport direction and ejecting a sheet having an image formed thereon downstream at a greater speed than a speed of the conveyor belt, while adsorbing the sheet; and
an electrostatic adsorptive electrode installed between one of the print heads located most downstream with respect to the sheet transport direction and the eject roller and producing electrostatic adsorptive power stronger than the adsorptive power of the eject roller when a sheet is positioned with its extension on both the print head located most downstream with respect to the sheet transport direction and the eject roller.
